(19) United States
(12) Patent Application Publication
(10) Pub. No.: US 2007/0264471 A1
(43) Pub. Date: Nov. 15, 2007

(54) Pre-primed roofing membrane

(75) Inventors: Joseph John Kalwara, Indianapolis, IN (US); Bernard Obereiner, Noblesville, IN (US); John William Fieldhouse, Westfield, IN (US)

Correspondence Address: Scott A. McCollister, Esq.;Fay, Sharpe, Fagan, Minnich & McKee, LLP, Seventh Floor, 1100 Superior Avenue, Cleveland, OH, 44114-2579, US

(73) Assignee: BFS Diversified Products, LLC

(21) Appl. No.: 11/432,048

(22) Filed: May 11, 2006

(51) Int. Cl. G11B 5/64; B29D 7/00; B05D 7/00

(52) U.S. Cl. 428/141; 427/407.1; 427/177

(57) ABSTRACT

There is provided a roofing membrane with factory applied non-tacky primer used as a primer in splicing adjacent panels of membrane together as well as roofing accessories and laminates using tape adhesive without the need to field prime the membrane. In addition, the primer is used to bond membrane that has been factory coated with a primer to substrates so only field adhesive applied on the substrate to receive membrane is required, without the need to field coat the membrane with adhesive.

### BACKGROUND

The present exemplary embodiments are directed toward a factory applied primer that can be applied to a roofing membrane during manufacture prior to the application of an adhesive.

The use of roofing systems capable of successfully maintaining their integrity, particularly their ability to prevent the entry of water resulting from their exposure to rain, snow, or other causes is a fundamental requirement for any successful building structure, particularly roofing in connection with flat or low-slope roofs installed on commercial, institutional, and industrial buildings.

In the past, a variety of roofing systems have been used in connection with such buildings including, for example, metal panel roofing. Another type of roofing commonly employed for such buildings is the so-called built-up roofing system. This type of roofing depends upon the application of asphaltic compounds to secure felt or other membranes over suitable insulation attached over metal roof decking.

Although somewhat effective, these roofing systems have limitations and drawbacks that make them unsuitable for all applications. In order to overcome the problems associated with such roofs, resort has increasingly been had to the use of roofing membranes formed from ethylene/propylene/non-conjugated diene rubber, EPDM, membranes. In this regard, EPDM membranes have proven to be well suited for roofing systems since they have a long life, substantial flexibility and retain their resiliency at very low temperatures. They are also distinguished by their ability to withstand the high temperatures frequently encountered in roofing environments without unduly stretching or softening, and by their possession of a high order of resistance to ultraviolet light. EPDM elastomers are usually blended with fillers, coloring agents, extenders, crosslinking agents and antioxidants to form compounded rubbers that are then calendered or extruded into sheets or membranes, typically about 7 to 40 feet wide, and 100 or more feet long.

Customarily roofing materials, made from plastic, rubber or ethylene propylene diene monomer (EPDM), have been spliced together on site with neoprene (polychloroprene) or butyl based contact adhesives. A well known treatise, the Handbook of Adhesives edited by Irving Skeist, published by Van Nostrand Reinhold Company, 1977 edition, at page 880, recommends the use of neoprene based adhesives on EPDM substrates.

EPDM membranes are a very popular form of single ply roofing. In any of several ways of preparing EPDM roofing seams, it is necessary that the talc or mica anti-stick agents be removed from the membrane surface prior to applying whatever adhesive system is to be used to join adjacent membrane sheets together. If the removal process is not thorough, the particles of talc or mica, as the case may be, prevent the adhesive material employed from thoroughly coating the surface area covered by the anti-stick agent. This then results in inferior adhesion, subsequent decoupling of the joint, and eventual penetration of water through the seam.

Therefore, it is desirable to use a primer on the EPDM membrane substrate before applying the neoprene or butyl based adhesives. These primers generally consist of a dilute solution of rubber and resins in a suitable solvent and are applied to the surfaces to be joined prior to application of the membrane adhesive in order to improve the final seam adhesion. The primer is applied and the solvent is allowed to evaporate before the application of the splice adhesive. The strength and durability of the final bond between adhesive and substrate depend greatly on the strength of the bond created by the primer. Conventional commercial primers typically provide poor bond strengths of about three to five pounds/inch when used with neoprene or butyl based adhesives when tested at room temperature.

These conventional commercial primers frequently contain environmentally undesirable ingredients such as lead salts and free isocyanates. When black conventional primers are used on white EPDM roofing membranes special techniques are necessary to prevent the black color of the primer from showing on the final adhered surface.

While the system described is conceptually simple, in practice it suffers from being both labor and material-intensive, and may result in relatively low seam peel strengths. Furthermore, for environmental and health reasons it is undesirable, and increasingly unlawful in specific air quality management districts, to use a system that employs so much volatile organic compound (VOC) in the form of required components, such as primers.

Partially to reduce the amount of VOC's, as well as to improve seam strengths, an alternative system has relied upon so-called splice tapes to obtain the necessary adhesion. Splice tapes, as the name implies, are tacky strips of tape adhesive commonly formed from butyl, EPDM, blends, or other rubbers, which are compounded to include rubber tackifiers and other agents required to impart adhesive qualities.

Nevertheless, the seaming process still entails the initial cleaning of the surfaces to be joined with a organic liquid cleaner-impregnated rag or scrub pad to remove anti-stick dusting powders. See, for example, U.S. Pat. Nos. 5,520,761 and 5,985,981, which describe a conventional primer and scrub pad applicator. Following such cleaning, a dilute seam primer containing from about 5 to 20 percent by weight of rubber in a solvent therefor is applied to the membrane seam overlap surfaces. Typical primers and methods for applying such primers can be found in U.S. Pat. Nos. 5,520,761 and 5,985,981. Following drying, tape is applied over the primed surfaces and pressure is applied to the seam to secure the necessary joinder.

While the use of splice tape eliminates the VOC's which would otherwise be present as a consequence of the solvents in seam adhesives, the need to clean the surfaces with liquid organics and the relatively large amount of solvents present in the very dilute primer make the escape of large amounts of VOC's to the atmosphere unavoidable. In addition, the need to perform both a cleaning process as well as a priming operation necessarily may result in relatively high installation costs as a result of the additional labor and material required.

In view of the foregoing, it would be desirable to be able join seams of adjacent roofing sheets as well as to bond a roofing membrane to a roofing substrate, whereby the need to perform separate cleaning or priming steps on the membrane is eliminated.

### BRIEF SUMMARY

In one embodiment this invention is a process for adhering EPDM roofing membranes comprising the steps of (a) forming a roofing membrane sheet, (b) coating the sheet with a primer, (c) allowing the primer to dry, wherein the primer is substantially non-tacky when dry, (d) winding the sheet to form a roofing membrane roll, wherein a release liner is not required, (e) transporting the roofing membrane roll to an installation site, and (f) installing the roofing membrane sheet at the installation site.

In a second embodiment, there is provided a method for producing a roofing membrane having pre-primed edges such that a step of applying primer to seams prior to installation in the field is not required . . .

In a third embodiment, there is provided a roofing membrane having a substantially non-tacky primer applied to at least a portion of one side of the roofing membrane.

### BRIEF DESCRIPTION OF THE DRAWINGS

FIG. 1 is a cross-sectional view of a preformed roofing membrane in accordance with one aspect of the present embodiments.

FIG. 2 is a cross-section of a seam splice of two sheets of roofing membrane in accordance with one aspect of the present embodiments.

### DETAILED DESCRIPTION

The present exemplary embodiments relate to the use of a factory applied non-tacky primer composition to roofing membranes such that the edges of the membrane sheets can be bonded together using a splicing adhesive and/or splice tape without the need for a separately applied primer in the field. In addition, the factory applied primer allows the bonding of the membrane to the substrate roof with only an application of field applied adhesive required vs. the two-sided application of typical bonding adhesives. The present embodiments thus eliminates the time consuming and costly step of first applying an adhesive to the sheet prior to bonding the sheet to a roofing substrate or prior to seaming the sheets to each other.

The present embodiments make use of a factory applied non-tacky primer composition to EPDM or other roofing membrane sheets such that a field applied primer is unnecessary when bonding the roofing sheets either to each other or to a roofing substrate. That is, the factory applied primer composition ensures adequate adhesion between roofing sheets both at the seams and to the underlying roof using conventional bonding adhesives and/or adhesive membrane splice tapes.

The primer should adhere to the roofing membrane and preferably allows one to achieve a seam peel strength of at least 2 lbs/in at 70° C. with the use of an adhesive tape. The primer should have no or minimal tack and in one embodiment, has a T_{g} of around 0° C.

Bonding adhesives for roofing membranes are generally solvent or water based contact adhesives applied (usually simultaneously) to the membrane and substrate (such as roofing insulation) to receive the membrane to be bonded. The adhesive's carrier (solvent or water) is allowed to evaporate until dry to the touch, and then the adhesive coated membrane is mated to the adhesive coated substrate.

A preferred membrane for use in the present embodiments is a single ply EPDM roofing membrane. Such membranes are commonly available in the industry and can contain any number of additional additives. Such additives may include, e.g., flame retardants, reinforcements, including both particulate and fibrous reinforcements, heavy and light filler, UV stabilizers, insecticides, bacteriostats, fungicides, surfactants, plasticisers, and other non-reactive diluents and the like.

In addition to use with EPDM roofing sheeting membranes, the process and primers of the present embodiments can be useful on other roof sheeting such as TPO, neoprene, Hypalon rubber (DuPont, Wilmington, Del.), PIB polyisobutylene, and polyvinyl chloride (PVC) sheeting.

The factory applied primer of this invention may be used in conjunction with most commonly used adhesives for bonding EPDM roofing membranes, such as polychloroprene and phenolic resinate. polychloroprene (neoprene) based contact cement adhesives. There are many neoprene (polychloroprene) based contact adhesives available commercially. These materials are dissolved in mixtures of solvents and modified with hydrocarbon resins, fillers, curatives and stabilizers. Examples of and formulations for these adhesives are documented in many sources and commercially available from many suppliers, including Ashland Specialty Chemical Co., Columbus, Ohio; Carlisle Corp., Carlisle, Pa.; and Royal Adhesives & Sealants LLC, South Bend, Ind.

Likewise, when splice tape is used to join the seams of the roofing membrane sheets, any type of conventionally used splice tape may be utilized. Such tapes are commercially available from various suppliers, Adco, Carlisle, and Firestone

For this invention, the membrane is coated in the factory with a coating- to serve as a primer for tapes and/or bonding adhesive. The coating type(s) may include, but are not limited to, the following coatings: polyvinylacrylates, polyvinylmethacrylates, polyisoprene, polyisobutylenes, polystyrene-methacrylate-copolymer, polystyrene-acrylate copolymer, polyvinylchloride, polyvinylidenedichloride, polyvinylidenedichloride-ethylene copolymer, polyvinylchloride-ethylene copolymer, polyvinylacetate, polyvinylacetate-ethylene copolymer, polystyrene, polystyrene-ethylene copolymer, polystyrene-isoprene copolymer, polystyrene-butylene copolymer, and polystyrene-butadiene copolymer.

An exemplary primer is a copolymer of esters of methacrylic acid and/or acrylic acid. The esters can be chosen to optimize the T_{g} of the coating, so as to prevent the primer coating from sticking to the EPDM during windup operation. The ester or esters also will be chosen so as to allow the primed EPDM surface to bond to the Bonding Adhesive with a low level of force. Such force is usually applied on a roof using an 18-24″ broom.

The factory applied coating on the membrane serves as a primer to receive tape products, and/or mate and bond/adhere to bonding adhesive(s). The primer should be such that, when dry, it is substantially non-tacky. By “substantially non-tacky” it is meant that the surface tack and adhesion should be such that the coated surface of the membrane will not adhere to an uncoated surface of the membrane when the membrane is in a rolled form to an extent that unrolling the membrane is prevented or becomes difficult. In another embodiment, the primer has no tack on a Polyken tack test.

The factory applied coating may be applied either mixed with a solvent or in a hot-melt form. If a solvent based application is used, the solvent is preferably one that will evaporate within a short time. Any solvent that will serve to adequately disperse the primer in solution is useful for purposes of the present invention. Suitable non-limiting examples of solvents include toluene, hexane, xylene, heptane, methanol and ethanol. Other solvents may include parachlorobenzotrifluoride, 1-dodecene, toluene, hexane, heptane, methylene chloride, 1,1,1-trichlorethane, xylene, 1-tetradecene, chloroform, and tetrachloro ethylene. It should be understood that a blend of solvents may be employed. An exemplary solvent is acetone or t-butyl acetate (both of which are VOC exempt). In one embodiment, the amount of solvent in the solvent/primer coating may be from 5-25 weight %.

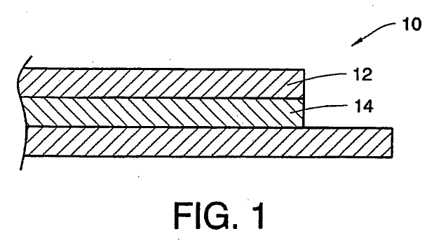

With reference now to FIG. 1, adhered to one side of a water impermeable membrane 12 is the primer coating 14. The primer coating 14 is applied directly to the water impermeable membrane 12 at the factory using most any suitable method well known in the art. For example, the if the primer coating 14 is in the form of a hot-melt, it may be applied directly to the water impermeable membrane 12 using a hot melt spray method or by using a slot die method as well know in the art. If the primer coating is a solvent applied composition, it can be applied, e.g., using roller applicators or by a spray on method.

When in the form of a hot melt, the primer coating 14 in accordance with the present invention are preferably solvent-free, and are characteristically solid at temperatures below 210 degrees F. (° F.), are low viscosity fluids above 210° F., and rapidly set upon cooling.

This invention eliminates field coating the membrane with primer and/or bonding adhesive which is a substantial labor-savings for roofing mechanics. In addition, the invention factory coats the membrane with primer in sufficient, metered consistent film thickness and eliminates variability of field application of primer to the membrane. Likewise, this invention eliminates the primer's solvent flash-off period otherwise required for primer field applied to membrane. Still another advantage of the present embodiments is that it eliminates the need for a primer application at a job installation site. This not only reduces installation time, it eliminates the use of high solvent content primers, which reduces the volatile organic compound (VOC) emission at the job site.

The present embodiments also include a roofing article incorporating the non-tacky primer composition of the present invention. To form the roofing article, the primer composition is applied to the desired substrate using any conventional means such as roll, slot die, spray, metering rod or extrusion coating. For purposes of defining and describing the present invention, it is noted that a roofing article comprises films, tapes, sheets and the like that are generally used to form roofing membranes or underlayments. The roofing article may be comprised of materials that are used in the commercial and residential roofing industry as waterproofing membranes or underlayments. Such materials include, but are not limited to, EPDM rubber, thermoplastic polyolefin (TPO), or reprocessed tire treads. Generally, the roofing membrane or underlayment is single-ply.

Sheets of EPDM roofing membrane are often prepared by a double calendering process in which two sheets of uncured material are pressed together by rollers to form a single sheet, the composite single sheet then being coated with talc or mica to prevent contacting surfaces from sticking together, wound into a roll and cured. The process of coating the roofing membrane can be accomplished at the end of the roofing manufacturing operation. That is, the membrane is preferably first manufactured, sized and cut into sheets prior to coating with the primer composition. However, the coating can also be done at other points in the production process.

The primer composition can be applied to the entire surface of one side of the roofing membrane or just to the edges of the membrane, depending on the method used to secure the membrane to the roof structure. That is, the primer can be applied to the entire surface of one side of the membrane sheet if a bonding adhesive will be used to adhere the membrane to the roof and the elimination of a field applied primer is desired. Conversely, if the membrane will be fastened to the roof using mechanical fasteners or other means and a primer is not needed, then only the edges of the membrane sheet may be coated to facilitate bonding the seams of the roofing sheets to each other without the need for a field applied primer.

Thus, in one embodiment, EPDM or other roofing material is processed and cut into sheets. At the end of the roofing manufacturing operation the primer composition is applied to the roofing sheets either as a hot melt or as solvent based composition. If a solvent based application is used, the solvent is preferably then allowed to dry. The sheets are then wound up to form rolls for easy transport. Due to the primer being substantially non-tacky, a release liner or backing layer is not required. The precoated rolls of roofing are shipped to the building site, unrolled and installed in the conventional manner except for the need to field prime the membrane to receive seam adhesion, tape or bonding adhesive. That is, as noted, the pre-applied primer eliminates the need for a field applied primer when joining the sheets to each other or the roofing substrate using either bonding adhesive or splice tape.

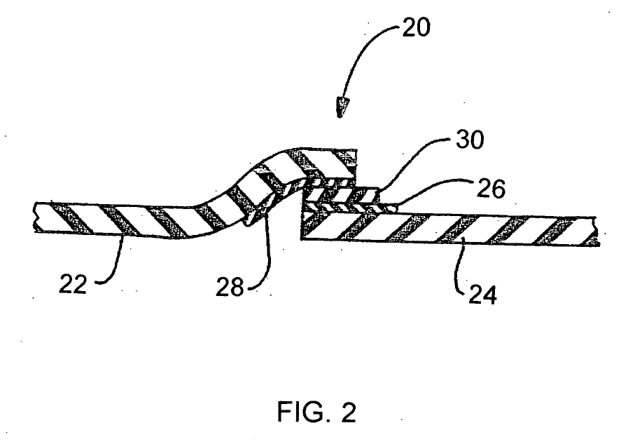

FIG. 2 is a side elevation of a roofing membrane sheet lap seam, generally 20. As shown in this figure, two adjacent membrane sheets, 22 and 24, are connected in an overlapping joinder seam. The upper surface of membrane 24 is coated with a layer of primer 26, while membrane 22 is similarly coated with a layer of primer 28. Interposed between the primer layers 26 and 28 is a splice tape 30. While equivalent methods may be employed, the following illustrates installation of the seam.

Two sheets are placed in an adjacent, side-by-side relationship, the edges overlapping by the desired seam amount, for example, from about 3 to 5 inches. A portion of the upper sheet is then folded back over itself and temporarily held in that position. The fold-back area will typically be about 1 foot wide. Whereas prior art membranes required an application of primer at this point, here the step of applying primer is dispensed with and instead, a strip of splice tape is applied to the primed upper surface of the membrane forming the overlap portion of the seam.

The splice tape, which is typically furnished in a roll as a laminate comprising the tape itself and a layer of release liner, is positioned with the release paper facing upwardly. Pressure is then applied, for example by a roller, to the release pliner surface of the tape, firmly setting and bonding the primed surface of the lower membrane to the exposed lower surface of the tape. Thereafter, the top membrane is allowed to fall over the release liner on the tape, but with a portion of the release paper extending visibly past the seam edge. The release paper is then pulled outwardly, away from the seam, thereby bringing the primed surface of the upper membrane into direct contact with the now exposed upper surface of the splice tape. Finally, pressure is applied to the upper membrane along the entire seam area, conveniently with a hand-held roller, to achieve a finished seam.

In accordance with the invention, the factory-prepared membrane is transported (as in a roll) to the field preparation site such as, for example, to a roofing installation. The membrane is then unrolled and installed as above.

As noted earlier, the factory application of primer to the membrane should preferably have minimal or no tack and adhesion to the bottom uncoated surface of the membrane so the membrane can be wound on a core, shipped, stored, and unwound easily on roof. If tack and adhesion are present to the extent that the factory coating adheres to the bottom, uncoated surface of the membrane, unwinding of the coated membrane will be difficult. A preferred embodiment is one where the primer coated membrane does not require a separate release liner. That is, the coated membrane should unroll without difficulty after production, shipment, storage, and roof placement.

What is claimed is:

1. A process for producing and installing a roofing membrane comprising the steps of (a) forming a roofing membrane sheet, (b) coating at least a portion of one side of the sheet with a primer composition, (c) allowing the primer composition to dry, wherein the primer composition is substantially non-tacky when dry, (d) winding the sheet to form a roofing membrane roll, wherein a release liner is not required, (e) transporting the roofing membrane roll to an installation site, and (f) unwinding and installing the roofing membrane sheet at the installation site.

2. The process of claim 1, wherein said roofing membrane comprises EPDM.

3. The process of claim 2, wherein said roofing membrane is a single ply membrane.

4. The process of claim 1, wherein said primer composition comprises at least one of polyvinylacrylate, polyvinylmethacrylate, polyisoprene, polyisobutylene, polystyrene-methacrylate copolymer, polystyrene-acrylate copolymer, polyvinylchloride, polyvinylidenedichloride, polyvinylidenedichloride-ethylene copolymer, polyvinylchloride-ethylene copolymer, polyvinylacetate, polyvinylacetate-ethylene copolymer, polystyrene, polystyrene-ethylene copolymer, polystyrene-isoprene copolymer, polystyrene-butylene copolymer, and polystyrene-butadiene copolymer.

5. The process of claim 1, wherein said primer composition comprises a copolymer of esters of methacrylic acid and/or acrylic acid.

6. The process of claim 1, wherein said primer composition is coated on said sheet as a solvent based solution.

7. The process of claim 6, wherein said solution comprises acetone and/or t-butyl acetate.

8. The process of claim 6, wherein said solution comprises from 5-25 weight percent solvent.

9. The process of claim 1, wherein said primer composition is coated on said sheet as a hot melt.

10. The process of claim 1, wherein step t) comprises applying a bonding adhesive to at least one of a roof substrate and said roofing membrane sheet and subsequently bonding said sheet to said roof substrate.

11. The process of claim 1, wherein step f) further comprises the sub-step of bonding the seams of adjacent roofing membrane sheets using an adhesive seam tape.

12. The process of claim 1, wherein said primer composition is only applied to one or more edges of said roofing membrane sheet.

13. A method for producing a roofing membrane having pre-primed edges such that a step of applying primer to seams prior to installation in the field is not required, said method comprising the steps of a) pressing two sheets of uncured EPDM membrane together to form a single sheet, b) winding said sheet into a roll, c) at least partially curing said EPDM, and d) coating the roofing membrane with a primer composition, wherein said primer composition is substantially non-tacky when dry.

14. The method of claim 13, wherein said single sheet is coated with talc or mica to prevent contacting surfaces from sticking together.

15. The method of claim 13, further comprising the step of sizing and cutting said EPDM sheet.

16. The method of claim 13, wherein step a) is performed by a calendering process wherein two sheets of uncured material are pressed together by rollers to form a single sheet.

17. A roofing membrane roll having a substantially non-tacky primer applied to at least a portion of one side of the roofing membrane, wherein said primer eliminates the need for a release liner in said roll.

18. The membrane roll of claim 17, wherein said roofing membrane comprises EPDM.

19. The membrane roll of claim 17, wherein said roofing membrane is a single ply membrane.

20. The membrane roll of claim 17, wherein said primer composition comprises at least one of polyvinylacrylate, polyvinylmethacrylate, polyisoprene, polyisobutylene, polystyrene-methacrylate copolymer, polystyrene-acrylate copolymer, polyvinylchloride, polyvinylidenedichloride, polyvinylidenedichloride-ethylene copolymer, polyvinylchloride-ethylene copolymer, polyvinylacetate, polyvinylacetate-ethylene copolymer, polystyrene, polystyrene-ethylene copolymer, polystyrene-isoprene copolymer, polystyrene-butylene copolymer, and polystyrene-butadiene copolymer.

21. The membrane roll of claim 17, wherein said primer composition is only present on the edges of said roofing membrane sheet.

22. The membrane roll of claim 17, wherein said primer composition comprises a copolymer of esters of methacrylic acid and/or acrylic acid.
